(19) United States
(12) Patent Application Publication
(10) Pub. No.: US 2026/0281973 A1
(43) Pub. Date: Sep. 17, 2026

(54) METHOD AND APPARATUS FOR USER EQUIPMENT SPECIFIC PAGING IN MOBILE COMMUNICATIONS

(71) Applicant: MEDIATEK INC., Hsinchu City (TW)

(72) Inventors: Yi-Ju LIAO, Hsinchu City (TW); Chien-Chun CHENG, Hsinchu City (TW); Wei-De WU, Hsinchu City (TW)

(73) Assignee: MEDIATEK INC., Hsinchu City (TW)

(21) Appl. No.: 19/472,879

(22) PCT Filed: Aug. 29, 2024
(86) PCT No.: PCT/CN2024/115372

§ 371 Date: Oct. 6, 2025

Related U.S. Application Data
(60) Provisional application No. 63/579,304, filed on Aug. 29, 2023.

(51) Int. Cl. H04W 68/02

(52) U.S. Cl. CPC H04W 68/02

(57) ABSTRACT

Various solutions for user equipment (UE) specific paging with respect to UE and network apparatus in mobile communications are described. An apparatus may perform a paging data channel monitoring. The performed paging data channel monitoring includes receiving a paging data channel from a network node and determining whether a UE specific information in the paging data channel indicates the apparatus. The apparatus may enter a connecting mode in an event that the UE specific information indicates the apparatus.

### CROSS REFERENCE TO RELATED PATENT APPLICATION(S)

The present disclosure is part of a non-provisional application claiming the priority benefit of U.S. Patent Application No. 63/579,304, filed 29 Aug. 2023, the content of which herein being incorporated by reference in its entirety.

### TECHNICAL FIELD

The present disclosure is generally related to mobile communications and, more particularly, to user equipment specific paging with respect to user equipment and network apparatus in mobile communications.

### BACKGROUND

Unless otherwise indicated herein, approaches described in this section are not prior art to the claims listed below and are not admitted as prior art by inclusion in this section.

In fifth-generation (5G) new radio (NR) network, a procedure called paging is used to find out the location of a user equipment (UE) before the actual connection between the UE and the base station has been established. In most cases, the paging process happens while UE is in a radio resource control (RRC) idle mode. This means that UE has to monitor whether the network is sending any paging message to it and it has to spend some energy to run this “monitoring” process. In the RRC idle mode, a UE enters into and stays in a sleep mode defined in discontinuous reception (DRX) cycle. The UE periodically wakes up and monitors physical downlink control channel (PDCCH) to check for the presence of a paging message. However, the UE may be unnecessarily awakened in the current group-based paging monitoring framework, which leads to unnecessary energy consumption at the UE. How to reduce the negative impact from false alarm rate for paging becomes an important issue in the newly developed wireless communication system. Therefore, there is a need to provide proper schemes for power consumption enhancement in paging procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to user equipment (UE) specific paging with respect to UE and network apparatus in mobile communications.

In one aspect, a method may involve an apparatus performing a paging data channel monitoring, which includes receiving a paging data channel from a network node and determining whether a UE specific information in the paging data channel indicates the apparatus. The method may also involve the apparatus entering a connecting mode in an event that the UE specific information indicates the apparatus.

In one aspect, an apparatus may comprise a transceiver which, during operation, wirelessly communicates with a network node. The apparatus may also comprise a processor communicatively coupled to the transceiver. The processor, during operation, may perform operations comprising performing a paging data channel monitoring including receiving a paging data channel from the network node via the transceiver, and determining whether a UE specific information in the paging data channel indicates the apparatus. The processor may also perform operations comprising entering a connecting mode in an event that the UE specific information indicates the apparatus.

In another aspect, a method may involve a network node transmitting a paging data channel to a UE. The method may also involve the network node receiving a connection request from the UE in an event that a UE specific information in the paging data channel indicates the UE. The method may further involve the network node establishing a connection with the UE for data transmission.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of user equipment specific paging in accordance with implementations of the present disclosure.

FIG. 2 is a diagram depicting an example structure of paging data channel in accordance with implementations of the present disclosure.

FIG. 3 is a diagram depicting another example scenario of user equipment specific paging in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to user equipment (UE) specific paging in mobile communications, so as to achieve better UE power consumption and paging latency trade-off. According to the present disclosure, a number of possible solutions may be implemented separately or jointly. That is, although these possible solutions may be described below separately, two or more of these possible solutions may be implemented in one combination or another.

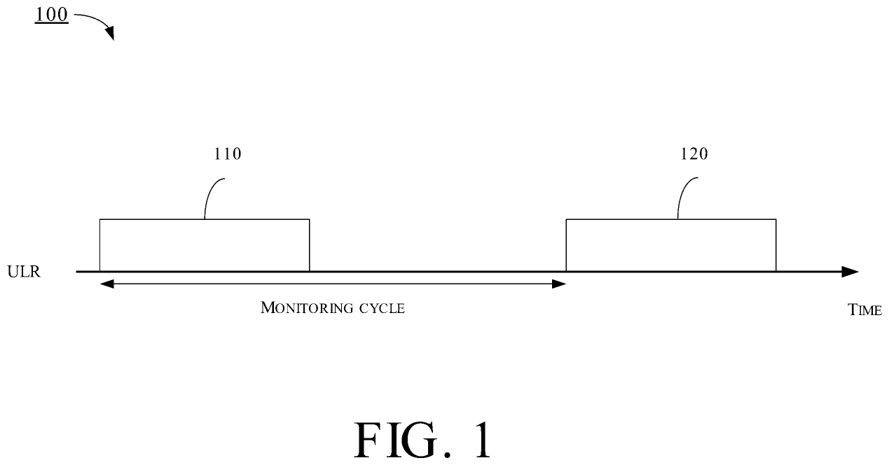

FIG. 1 illustrates an example scenario 100 of UE specific paging in which various solutions and schemes in accordance with the present disclosure may be implemented. In scenario 100, the UE uses its ultra-low power radio/receiver (ULR) to perform a paging data channel monitoring in each monitoring occasion. For example, during each paging data channel monitoring 110 or 120, the UE receives a paging data channel from a network node (e.g., a base station). The paging data channel includes a UE specific information, which is a unique identifier associated with only one device in the network. That is, the network node uses one paging data channel to page one device at a time, so that the paging false alarm rate can be reduced. The UE determines whether it is paged based on the UE specific information in the received paging data channel, and then enters a connecting mode in an event that the UE specific information indicates itself.

In one embodiment, the paging data channel may be a paging message, and the payload of the paging data channel comprises one or more concatenated sequences. The UE may directly check the received paging data channel for its identifier by applying a sequence matching process via the ULR. As the sequence detection can be performed by a simple receiver, the power consumption for the paging data channel monitoring is lower than that of the conventional paging technique. The sequence may be m-sequence, gold-sequence, ZC sequence or low-density power boosting (LDPB) sequence, however the present disclosure is not limited thereto. In one embodiment, each sequence may carry 1 or multiple bits. For example, to deliver 8 bits information, the network node may transmit 8 concatenated sequences and each sequence carries 1-bit information. The UE receives 8 sequential sequences to determine whether it is paged.

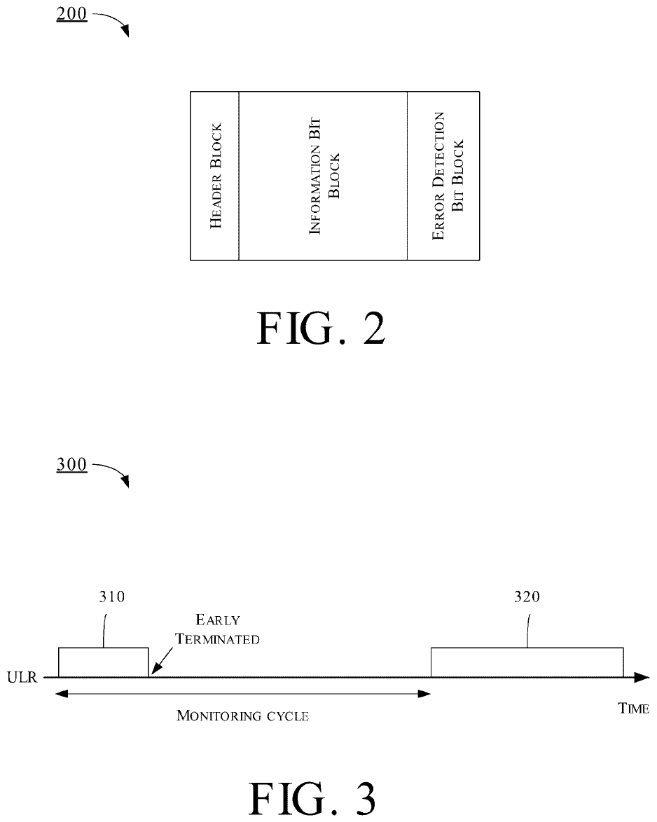

FIG. 2 illustrates an example structure 200 of the paging data channel in accordance with implementations of the present disclosure. In structure 200, the paging data channel comprises a header block, an information bit block, and an error detection bit block. The header block may indicate the type of channel format. For example, to indicate whether this channel is for UE specific paging information, common message, or master information block (MIB). The information bit block may carry the UE specific information when the channel is for UE specific paging information. In one example, the UE specific information may be a UE identifier (UEID), such as a 48 bits UEID for a UE in a radio resource control (RRC) idle mode and a 40 bits UEID for a UE in an inactive mode. In another example, the UE specific information may be a UE paging identifier (ID) configured by the network node via a higher layer signaling (e.g., RRC release message). The UE paging ID is shorter than the UEID, therefore, the resource overhead for one data channel can be reduced. The error detection bit block may carry one or more cyclic redundancy check (CRC) bits. In one example, 8 CRC bits are used for achieving 1% false alarm rate.

FIG. 3 illustrates another example scenario 300 of UE specific paging in which various solutions and schemes in accordance with the present disclosure may be implemented. In scenario 300, the payload of the paging data channel comprises one or more concatenated sequences, and the UE may early terminate the paging data channel monitoring in an event that at least one of the concatenated sequences does not match its identifier. For example, it is assumed that the payload of the paging data channel comprises 8 sequences. When performing the paging data channel monitoring 310, if the UE detects that the first sequence mismatches the identifier of the UE, the paging data channel monitoring may be terminated without processing the rest of the 7 sequences. On the other hand, the next paging data channel monitoring 320 is fully performed as the UE determines that the UE specific information in the received paging data channel indicates its identifier.

To perform the paging data channel monitoring, one or a combination of the periodicity of paging data channel monitoring (also referred to as the paging data channel periodicity), the frequency resource (e.g., the starting resource block and the resource block number), the sequence repetition number, the sequence root for information indication and sequence generation, and the cyclic shift for information indication and sequence generation are configured via higher layer signaling such as the MIB, System Information Blocks (SIBx) or RRC release message. The UE may receive at least one of the foregoing configurations for performing the paging data channel monitoring. If the periodicity of paging data channel monitoring is not configured, the UE monitors the paging data channel with a default periodicity. If the sequence repetition number is not configured, the UE receives the paging data channel with a default repetition number (e.g., 1 or a predetermined number larger than 1); Otherwise, the signal is transmitted with replica according to the sequence repetition number.

In one embodiment, the UE determines a monitoring occasion of the paging data channel based on one or a combination of the UEID, the paging data channel periodicity, and a monitoring occasion number within a time duration. Then the UE monitors the paging data channel based on the monitoring occasion. For example, the monitoring occasion slot may be determined by the following relation:
UEID mod paging data channel periodicity in a slot

In the foregoing embodiments, the UE uses its ULR to perform the paging data channel monitoring. However, it should be noted that the schemes proposed in the present disclosure are not restricted to the architecture of dual radio layer (e.g., main receiver (MR) and ULR). In some implementations, it is also applicable to single radio layer or single transmitter (TX)/receiver (RX) only. For example, for a UE equipped with a MR and a ULR such as the eMBB UE, the UE may use the ULR to perform the paging data channel monitoring. For a UE such as a IoT device which equipped with a single RX (e.g., ULR only), the paging data channel monitoring is performed by the ULR.

### Illustrative Implementations

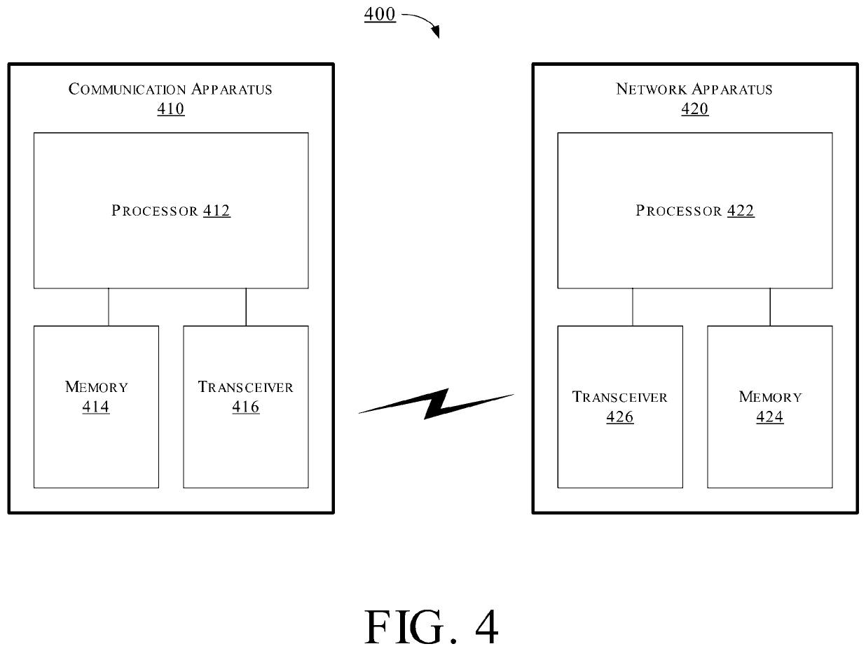

FIG. 4 illustrates an example communication system 400 having at least an example communication apparatus 410 and an example network apparatus 420 in accordance with an implementation of the present disclosure. Each of the communication apparatus 410 and network apparatus 420 may perform various functions to implement schemes, techniques, processes and methods described herein pertaining to UE specific paging in mobile communications, including scenarios/schemes described above as well as process 500 and process 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Communication apparatus 410 may also be implemented in a smartphone, a smartwatch, a personal digital assistant, a digital camera, or a computing equipment such as a tablet computer, a laptop computer or a notebook computer. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of the processor 412 and processor 422 may be implemented in the form of one or more single-core processors, one or more multi-core processors, or one or more CISC processors. That is, even though a singular term “a processor” is used herein to refer to processor 412 and processor 422, each of the processor 412 and processor 422 may include multiple processors in some implementations and a single processor in other implementations in accordance with the present disclosure. In another aspect, each of the processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and processor 422 is a special-purpose machine specifically designed, arranged and configured to perform at least a part of the specific tasks including UE specific paging in a device (e.g., as represented by communication apparatus 410) and a network node (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may comprises a main receiver and a low power receiver. In some implementations, transceiver 416 may comprises only a low power receiver. In some implementations, communication apparatus 410 may further include a memory 414 coupled to processor 412 and capable of being accessed by processor 412 and storing data therein.

In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

For illustrative purposes and without limitation, descriptions of capabilities of each of communication apparatus 410 and network apparatus 420 are provided below with process 500 and process 500. In which, the communication apparatus 410 is implemented in or as a communication apparatus or a UE and network apparatus 420 is implemented in or as a network node of a communication network.

### Illustrative Processes

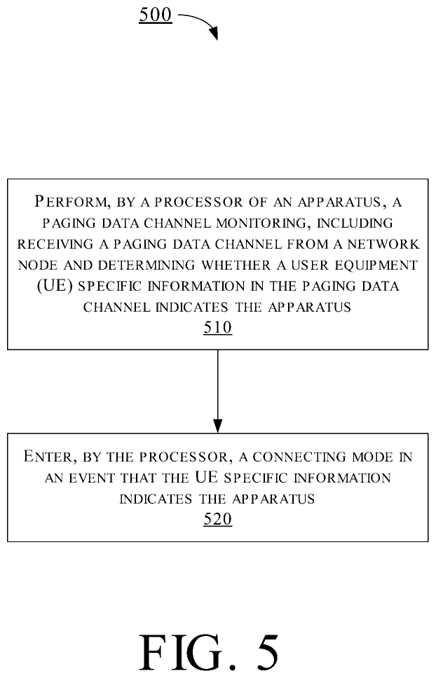

FIG. 5 illustrates an example process 500 in accordance with an implementation of the present disclosure. Process 500 may be an example implementation of above scenarios/schemes, whether partially or completely, with respect to UE specific paging in mobile communications. Process 500 may represent an aspect of implementation of features of communication apparatus 410. Process 500 may include one or more operations, actions, or functions as illustrated by one or more of blocks 510, and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410 as a UE. Process 500 may begin at block 510.

At 510, process 500 may involve processor 412 of communication apparatus 410 performing a paging data channel monitoring, including receiving a paging data channel from a network node (e.g., the network apparatus 420), and determining whether a UE specific information in the paging data channel indicates the apparatus (e.g., the communication apparatus 410). Process 500 may proceed from 510 to 520.

At 520, process 500 may involve processor 412 entering a connecting mode in an event that the UE specific information indicates the apparatus (e.g., the communication apparatus 410).

In some implementations, a payload of the paging data channel comprises one or more concatenated sequences.

In some implementations, process 500 may involve processor 412 applying a sequence matching process to determine whether the UE specific information indicates the apparatus.

In some implementations, process 500 may involve processor 412 terminating the paging data channel monitoring in an event that a specific sequence among the concatenated sequences mismatching the apparatus is detected.

In some implementations, the paging data channel comprises one or a combination of a header block, an information bit block, and an error detection bit block.

In some implementations, the UE specific information is carried by the information bit block.

In some implementations, the UE specific information comprises a UE identifier (UEID).

In some implementations, the UE specific information comprises a UE paging identifier (ID) configured by the network node.

In some implementations, the UE paging ID is shorter than a UEID.

In some implementations, process 500 may involve processor 412 receiving one or more configurations for performing the paging data channel monitoring. Besides, process 500 may involve processor 412 determining a monitoring occasion of the paging data channel based on one or a combination of a UEID, a paging data channel periodicity, and a monitoring occasion number within a time duration. Also, process 500 may involve processor 412 monitoring the paging data channel based on the monitoring occasion.

In some implementations, the configurations relate to one or a combination of the paging data channel periodicity, a frequency resource, a sequence repetition number, a sequence root for information indication and sequence generation, and a cyclic shift for information indication and sequence generation.

In some implementations, a default periodicity is used by the processor 412 in an event that the one or more configurations are not related to the paging data channel periodicity. Further, a default repetition number is used by the processor 412 in an event that the one or more configurations are not related to the sequence repetition number.

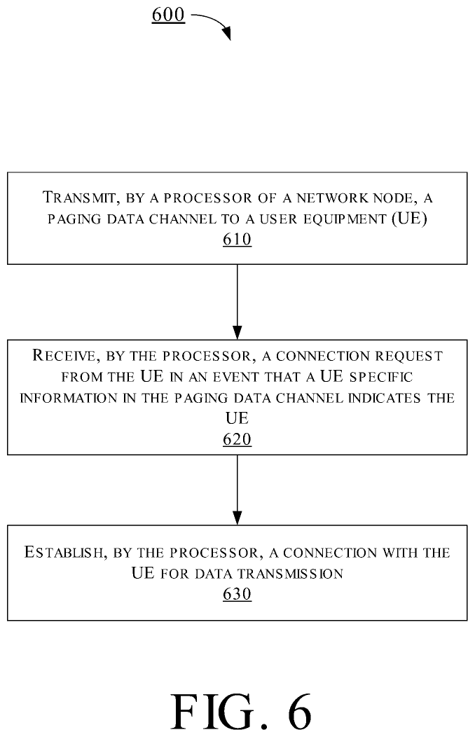

FIG. 6 illustrates an example process 600 in accordance with an implementation of the present disclosure. Process 600 may be an example implementation of above scenarios/schemes, whether partially or completely, with respect to UE specific paging in mobile communications. Process 600 may represent an aspect of implementation of features of network apparatus 420. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any base stations or network nodes. Solely for illustrative purposes and without limitation, process 600 is described below in the context of network apparatus 420. Process 600 may begin at block 610.

At 610, process 600 may involve processor 422 of network apparatus 420 transmitting a paging data channel to a UE (e.g., the communication apparatus 410). Process 600 may proceed from 610 to 620.

At 620, process 600 may involve processor 422 receiving a connection request from the UE in an event that a UE specific information in the paging data channel indicates the UE. Process 600 may proceed from 620 to 630.

At 630, process 600 may involve processor 422 establishing a connection with the UE for data transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a paging data channel monitoring, comprising:
receiving a paging data channel from a network node;
determining whether a user equipment (UE) specific information in the paging data channel indicates the apparatus; and
entering, by the processor, a connecting mode in an event that the UE specific information indicates the apparatus.

2. The method of claim 1, wherein a payload of the paging data channel comprises one or more concatenated sequences.

3. The method of claim 2, wherein the determining of whether the UE specific information indicates the apparatus further comprises:
applying a sequence matching process to determine whether the UE specific information indicates the apparatus.

4. The method of claim 2, further comprising:
terminating, by the processor, the paging data channel monitoring in an event that a specific sequence among the concatenated sequences mismatching the apparatus is detected.

5. The method of claim 1, wherein the paging data channel comprises one or a combination of a header block, an information bit block, and an error detection bit block.

6. The method of claim 5, wherein the UE specific information is carried by the information bit block.

7. The method of claim 1, wherein the UE specific information comprises a UE identifier (UEID).

8. The method of claim 1, wherein the UE specific information comprises a UE paging identifier (ID) configured by the network node.

9. The method of claim 1, wherein the performing of the paging data channel monitoring further comprises:
receiving, by the processor, one or more configurations for performing the paging data channel monitoring;
determining a monitoring occasion of the paging data channel based on one or a combination of a UEID, a paging data channel periodicity, and a monitoring occasion number within a time duration; and
monitoring the paging data channel based on the monitoring occasion.

10. The method of claim 9, wherein the one or more configurations relate to one or a combination of the paging data channel periodicity, a frequency resource, a sequence repetition number, a sequence root for information indication and sequence generation, and a cyclic shift for information indication and sequence generation.

11. The method of claim 10, wherein:
a default periodicity is used by the processor in an event that the one or more configurations are not related to the paging data channel periodicity; and
a default repetition number is used by the processor in an event that the one or more configurations are not related to the sequence repetition number.

12. An apparatus, comprising:
a transceiver which, during operation, communicates wirelessly; and
a processor communicatively coupled to the transceiver such that, during operation, the processor performs operations comprising:
performing a paging data channel monitoring, comprising:
receiving, via the transceiver, a paging data channel from a network node;
determining whether a user equipment (UE) specific information in the paging data channel indicates the apparatus; and
entering a connecting mode in an event that the UE specific information indicates the apparatus.

13. The apparatus of claim 12, a payload of the paging data channel comprises one or more concatenated sequences.

14. The apparatus of claim 13, wherein, during operation, the processor further performs operations comprising:
applying a sequence matching process to determine whether the UE specific information indicates the apparatus.

15. The apparatus of claim 13, wherein, during operation, the processor further performs operations comprising:
terminating the paging data channel monitoring in an event that a specific sequence among the concatenated sequences mismatching the apparatus is detected.

16. The apparatus of claim 12, wherein the paging data channel comprises one or a combination of a header block, an information bit block, and an error detection bit block, and the UE specific information is carried by the information bit block.

17. The apparatus of claim 12, wherein the UE specific information comprises a UE identifier (UEID).

18. The apparatus of claim 12, wherein the UE specific information comprises a UE paging identifier (ID) configured by the network node.

19. The apparatus of claim 12, wherein, during operation, the processor further performs operations comprising:
receiving, via the transceiver, one or more configurations for performing the paging data channel monitoring;
determining a monitoring occasion of the paging data channel based on one or a combination of a UEID, a paging data channel periodicity, and a monitoring occasion number within a time duration; and
monitoring the paging data channel based on the monitoring occasion.

20. The apparatus of claim 19, wherein the one or more configurations relate to one or a combination of the paging data channel periodicity, a frequency resource, a sequence repetition number, a sequence root for information indication and sequence generation, and a cyclic shift for information indication and sequence generation.

21. The apparatus of claim 20, wherein:
a default periodicity is used by the processor in an event that the one or more configurations are not related to the paging data channel periodicity; and
a default repetition number is used by the processor in an event that the one or more configurations are not related to the sequence repetition number.

22. A method, comprising:
transmitting, by a processor of a network node, a paging data channel to a user equipment (UE);
receiving, by the processor, a connection request from the UE in an event that a UE specific information in the paging data channel indicates the UE; and
establishing, by the processor, a connection with the UE for data transmission.
